(19) United States
(12) Patent Application Publication
(10) Pub. No.: US 2016/0128288 A1
(43) Pub. Date: May 12, 2016

(54) SELF-WATERING, SELF-LIGHTING HYDROPONIC SYSTEM

(71) Applicant: Ohneka Farms LLC, Redwood City, CA (US)

(72) Inventors: Gabrielle Pettinelli, Redwood City, CA (US); Eric Defeo, Redwood City, CA (US)

(21) Appl. No.: 14/935,927

(22) Filed: Nov. 9, 2015

Related U.S. Application Data
(60) Provisional application No. 62/076,763, filed on Nov. 7, 2014.

(51) Int. Cl. A01G 31/02; H04B 17/00; A01G 7/04

(52) U.S. Cl. CPC A01G 31/02; A01G 7/045; H04B 17/00; A01G 2031/006

(57) ABSTRACT

A self-watering and self-lighting hydroponic system is disclosed for optimal plant growth. The apparatus comprises of a reservoir that contains nutrient-rich aqueous solution, a structure that incorporates plant pods, a light system to optimally grow plants at desired wavelengths, and a power source. The growing medium and container may be self-standing or attached to another container in a modular fashion. A tube for transporting nutrient rich solution is connected to a reservoir in the base of the apparatus. The specified flow rate of the solution may be dictated by manual or app driven technology. The tube is connected to an elevated emitter and positioned so the solution disperses evenly throughout the system.

### REFERENCE TO RELATED APPLICATION

This application claims priority to U.S. Provisional Patent Application Ser. No. 62/076,763, filed Nov. 7, 2014, the entire content of which is incorporated herein by reference.

### FIELD OF THE INVENTION

This invention relates generally to hydroponics and, in particular, to a self-watering and self-lighting system to optimize plant growth.

### BACKGROUND OF THE INVENTION

Living plants improve space aesthetically, improve air quality, and are therefore particularly desirable in occupied living spaces. In recent years, there has been a surge in the number of people who wish to grow their own food, especially in environments where the task was once daunting—such as indoor or in city spaces. So-called “food deserts,” areas where little fresh food is easily accessible, have become prevalent in cities around the world where residents tend to consume processed, packaged, or canned food with depleted nutrients.

There is accordingly a need for system and/or method that enables a person to grow a large assortment of plants for a variety of purposes in a hydroponic environment without taking up too much space or using up their window sources for natural sunlight. Also, many urban dwellings have limited to little or no window space which makes growing one's own food difficult. Growing plants for consumption provides cost savings on impending surges in food prices. Additionally, the cultivation of plants has been proven to foster a healthy lifestyle through dietary and therapeutic benefits.

Many people find the task of watering plants on a schedule to be overwhelming. People tend to either overwater or underwater their vegetation that results in plant loss. A significant amount of time and energy is required to support plant life, which can incorporate watering, weeding, pruning etc. In the past, both aeroponic and hydroponic systems have been tested. Hydroponics is said to provide healthier plants that grow faster than those grown in soil. Although hydroponic proves to deliver maximum nutrition to plant roots in addition to proper aeration, in the absence of a soil substitute larger systems are required to house these structures. Additionally, some hydroponic methods do not allow optimal ventilation for the root system.

To address these issues, aeroponics was used to grow plants in an air or mist environment. Some large scale aeroponics and hydroponic devices cannot be easily incorporated into smaller environments, where there is demand for self-contained plants systems.

### SUMMARY OF THE INVENTION

The present invention addresses the deficiencies of the prior art with respect to hydroponic growing. This invention manifests a hybrid of both technologies (i.e. hydroponic and aeroponics) that allows plants to grow optimally, but in a smaller system using a spraying technology. A plurality of plants arranged in a growing structure are illuminated using “near-sunlight” conditions to enhance their growth potential, and thereby, maximize plant production per unit area or per unit volume.

The preferred embodiments take the form of a self-contained hydroponic system for growing a plurality of plants configured as plant pods, each pod having a root portion and a foliage portion. The system includes a vessel having a wall with an outer surface, an upper end, and an interior with a reservoir containing an aqueous solution. The wall of the vessel includes a plurality of holes, each adapted to receive one of the plant pods, such that the root portions of the pods are within the interior of the vessel and the foliage portions extend away from the outer surface of the vessel. A pump, connected to an emitter within the interior of the vessel, delivers the aqueous solution to the root portions of the plant pods, and a light system coupled to the upper end of the vessel illuminate the foliage portions.

The pump may be a submersible pump, and the apparatus may include a tube coupled to the emitter, and/or a plant support structure. As an example, the apparatus may include a trellis-like body containing multiple openings throughout the structure that may retain seed containers. In all embodiments, plant foliage is offset from top to bottom, allowing all plants to receive an adequate amount of light.

A preferred embodiment may have a liquid conduit to transport a nutrient-rich aerated aqueous solution vertically upwards from the base reservoir to the top adjustable emitter using a submersible pump. A height-adjustable emitter may be provided to disperse the solution evenly throughout the structure, propelling the solution to all plant roots contained within the apparatus.

The irrigation portion of the apparatus may further comprise a base support integrated into the reservoir base that connects to the outer trellis structure by a series connection points. The base support may include a container holding solution in communication with the pump, such that the pump, reservoir, and tube form a closed-loop, re-circulating system. In another non-limiting embodiment, the base connects to more than one trellis system and all trellis systems return their solution to the reservoir; wherein the reservoir, pump, trellis systems, and multiple tubes form a re-circulating system.

In the preferred embodiment the light system includes surface-mounted LEDs configured to deliver light to the most plants. The light system will act as a grow light that provides the radiation necessary for the plants to grow. The light system may illuminate all plants contained within the system in multiple lighting patterns controlled by the user by means of a mobile app or manual control.

The light system may also have a light sensor that regulates the LED output based on the ambient light found within the surrounding environment. The invention may further include a clock module which allows the system to continue timing during power outages. When main power resumes, the LEDs and associated electronic devices return to their proper states based on the clock module. The clock module may also work in communication with a Bluetooth module or Wi-Fi chip in some embodiments. LED frequencies chosen at specific wavelength ranges may be pre programmed for optimal plant growth. The light system may be controlled by app-driven software. In other non-limiting embodiment, the hydroponic growing apparatus may have a wall mounted structure comprising of multiple shelves. The apparatus can be irrigated through an arrangement similar to a multi-trellis system.

### BRIEF DESCRIPTION OF THE DRAWINGS

FIG. 1 is an elevated view of the apparatus including its planting components;

FIG. 2 is a perspective view of another embodiment of the present invention;

FIG. 3 is a bottom perspective view looking up towards the LED light system;

FIG. 4 is a section view of the electrical and mechanical components of the embodiment;

FIG. 5 is a section view showing the vessel may be disassembled into multiple pieces for easy cleaning; and

FIG. 6 is a block diagram illustrating major electronic components and subassemblies.

### DETAILED DESCRIPTION OF THE INVENTION

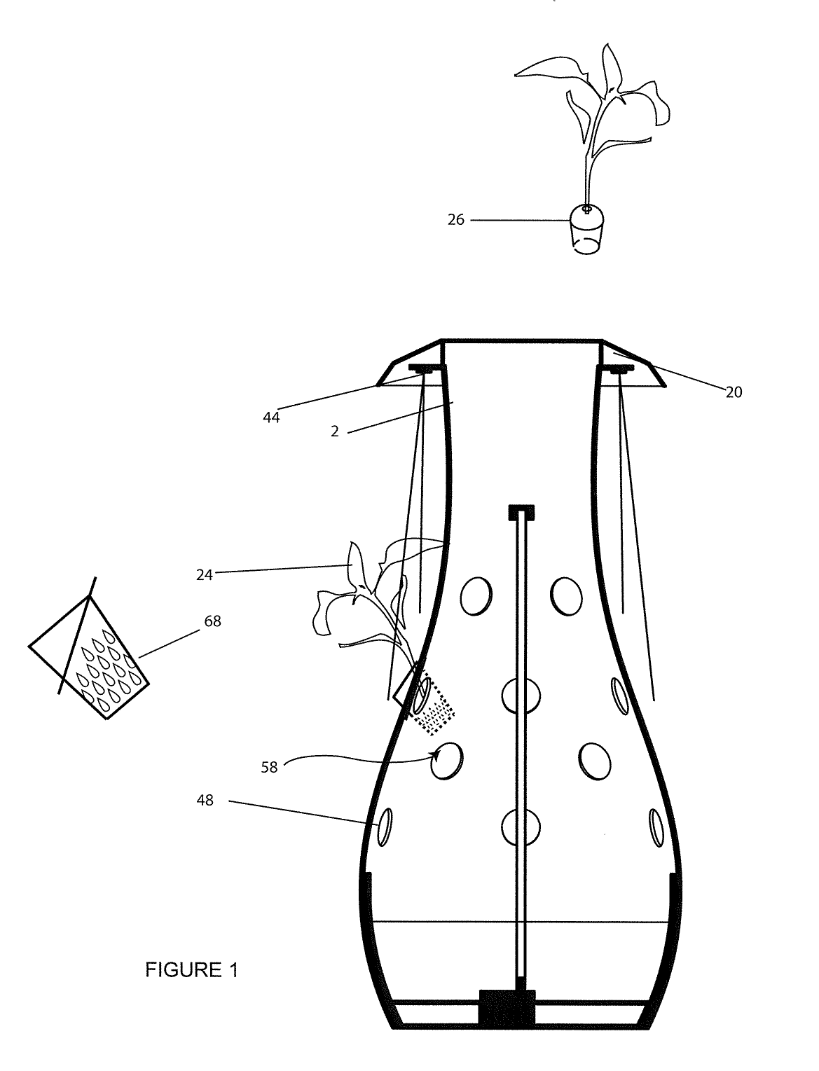

This invention relates to a closed-loop hydroponic system and method. As shown in FIG. 1, the hydroponic growing apparatus comprises of a generally conical vessel 48 which can be made from a variety of flexible or solid materials such as but not limited to plastic, recycled materials, fabric, or silicone. The generally conical vessel 48 contains plurality of openings 58 that may be structured as open pods in any number of configurations.

The opening 58 may contain a net pot 28 that is configured to accommodate a substrate plant plug 26. In another embodiment, the growth of plant 24 may be in a substrate tube. The apparatus 10 may be configured for different type of plants 24 and may use different substrates 36 such as but not limited to growing sponge, clay pellets, or grow stones. The apparatus 10 is constructed so as not to expose the inside of the apparatus 10 to the outside light and for that reason such construction hampers the growth of unwanted bacteria and mold.

The apparatus 10 further comprises a reservoir 62 that stores nutrient rich solution as well as insulates the solution from any external contaminants. Any excessive unused solution from the plants 24 that may be dripping is channeled back to the reservoir 62. The reservoir 62 may be constructed from a variety of materials in different shapes or sizes.

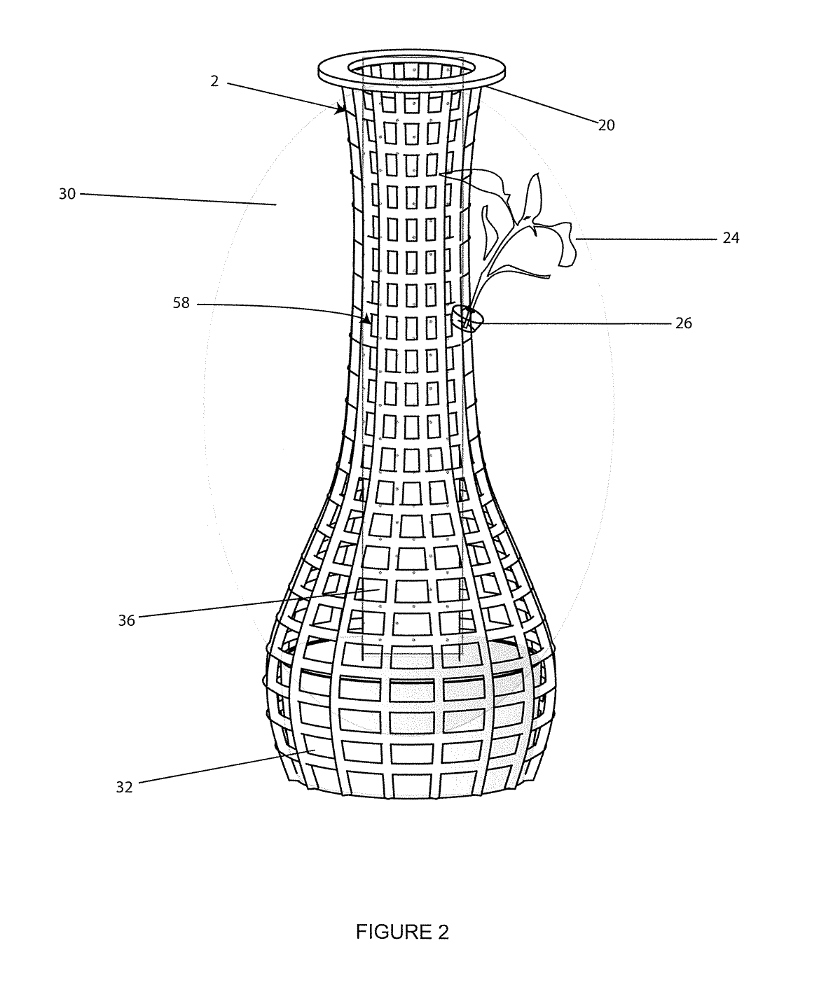

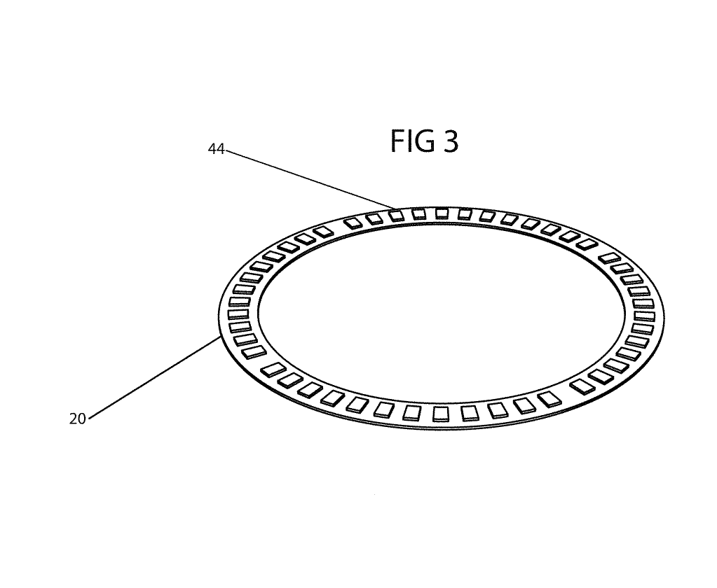

The apparatus 10 further comprises a light system 20. The light system 20 may include a plurality of LEDs 44 and the light system 20 provides light/radiation 30 (see FIG. 2) to support plants 24. FIG. 2 shows another embodiment of the apparatus 10. As shown in FIG. 3, LEDs 44 may be mounted circumferentially on one or more rings using a mounting process, such as surface mount technology (SMT). SMT facilitates dense population of the SMT components i.e. LED 44 on the printed circuit board (PCB). In the preferred embodiment there are several light rings connected in series to accommodate lighting on each side on the planter.

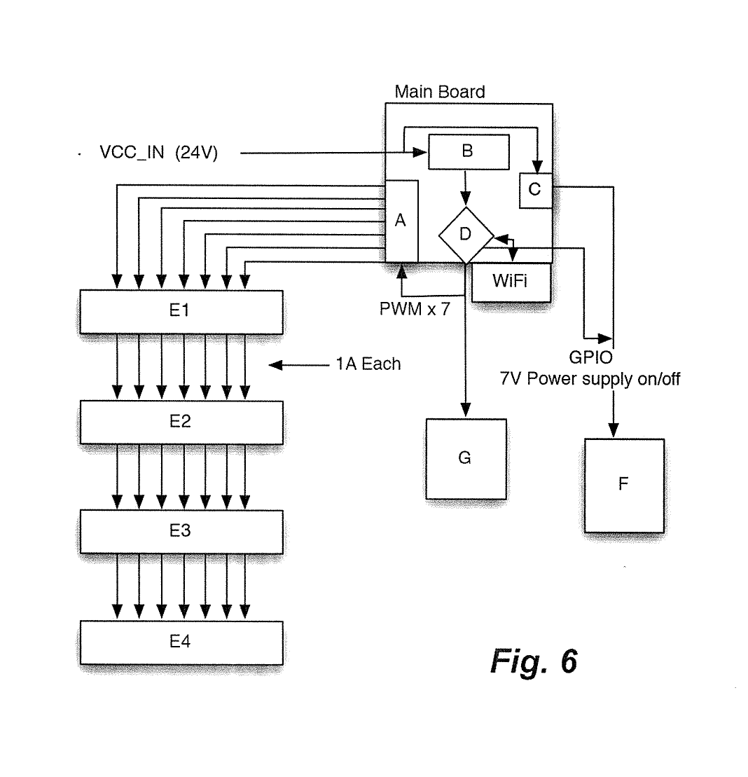

FIG. 6 is a system block diagram illustrating major components and subsystems. The system is controlled by a main board including a programmed microcontroller unit (MCU) labelled D in the diagram. The MCU interfaces to other subsystems including the WiFi unit and LEDs (E1-E4) through LED drivers A. VCC power is provided at 24 volts, which is stepped down at B to provide 3.3 volts for the MPU and 7 volts to power pump F. The MPU also interfaces to depth sensor, labelled G.

When used for indoor growing, LED-based lights have the advantage of being more efficient than other lights. LED-based light utilizes less electricity and radiates less heat that causes water evaporation. In addition, LEDs can be focused on the photo-synthetically active regions of the light spectrum, specifically blue and red (400-500 nm and 600-700 nm respectively), which activates seedling and supports blooming phases of plant growth. LEDs improve efficiency by eliminating the need for reflectors used in the prior art. Finally, LEDs may have a lifetime of over 50,000 hours in comparison to less than 10,000 hours for High Intensity Discharge (HID) systems that lowers their overall lifetime cost of operation.

The light system 20 may have a variety of lighting configurations in a range of wavelengths and may include but not limited to blue, deep blue, red, deep red, and white. The embodiment may have different configuration of wavelengths connected in series. The invention may use a combination of different wavelengths in a singular light system 20. The light system 20 may be controlled by a user by means of a mobile app or manual control.

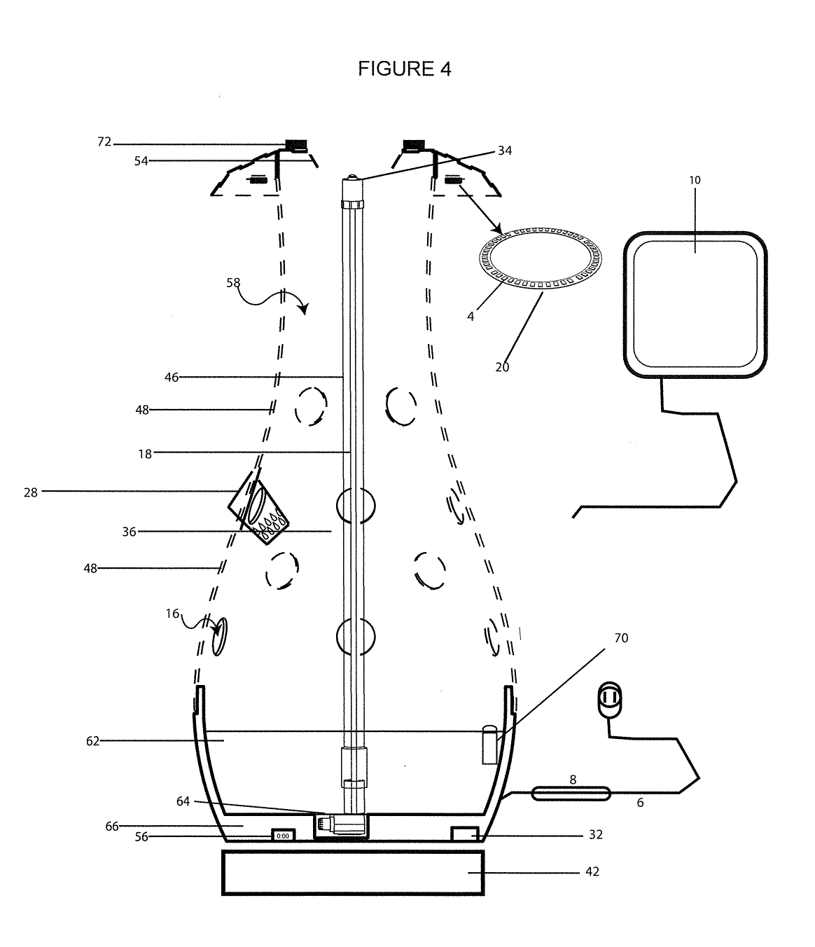

As shown in FIG. 4, the apparatus 10 may be powered by main power supply using a transformer 8 and an electrical cord 6. Alternatively, the apparatus 10 may be powered by a solar panel 90 or a detachable battery unit 42. Solution may be added to the apparatus 10 via a top funnel opening 54. The reservoir 62 may have a significantly large volume for a larger, floor standing apparatus. The generally conical vessel 48 may rest upon or be connected with the reservoir 62 with the use of support elements such as but not limited to secure hooks, snaps, or rib connections. In the preferred embodiment, however, the vessel disassembles into multiple pieces shown by the horizontal broken lines, facilitating ease of cleaning. The various components may be held in position with any appropriate arrangement including nesting or frictional fit between the pieces.

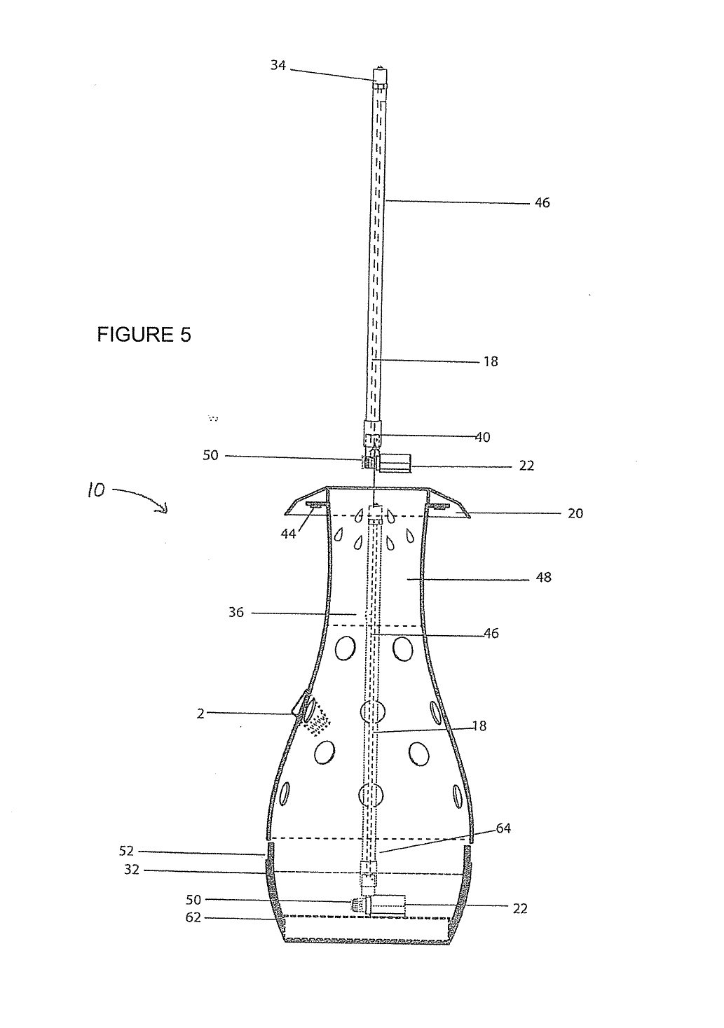

As shown in FIG. 5, the submersible pump 22 may be situated in the reservoir 62, wherein a tube 18 may vertically transport solution from the reservoir 62 upwards to the top emitter 34. In the preferred embodiment the tube supplies both the solution and air for aeration purposes. In addition, the water propels from the emitter and is evenly dispersed using a “dispenser cup” that channels water down the walls of the planter directly into the net pots via ‘grooves’ on the inside wall of the body. In the preferred embodiment, there are a plurality of such grooves immediately above and orient toward each net pot receiving aperture, such that water from the emitter clinging to the inside of the body is guided by these grooves onto the respective plant pods disposed in the various net pots.

Because different plants need different amount of water or nutrition, the emitter 34 may be adjustable so as to control the flow of solution. The reservoir opening 64 in reservoir 62 may be configured to connect with the one end of a tube 18. The other end of the tube 18 may be connected to the emitter 34. Filter 50 may be used to safeguard intake of the submersible pump 22 from becoming clogged with particulate matter that may build-up in the bottom of the reservoir 62. The reservoir 62 may be sealed from the electrical components underneath by an electrical storage space 66. While a float switch may alternatively be used, reservoir 62 preferably includes a depth level sensor 70 to monitor the solution level. The indicator ring 72 may give a low solution level signal, such as but not limited to visual or audio, to enable the user to add more solution. The indicator ring 72 may be positioned relative to the light system 20 to make the indicator ring 72 easy to observe by the user.

Also shown in FIG. 5, the emitter 34 may allow for uniform distribution of the solution for the plants 24. The apparatus 10 may have a support tube 46 around the tube 18 to provide extra protection. Alternatively, the irrigation tube may be clipped to the support tube instead of being disposed within it. Regardless of the relative placement the support tube and irrigation tubes function in the same manner.

The tube 18, the support tube 46 and the submersible pump 22 may be removed from the apparatus 10 through the funnel opening 54. The funnel opening 54 may be used to access the reservoir 62 for cleaning and maintenance purposes. Additionally, the apparatus 10 may have a bottom entrance 52 that can be manipulated to access the reservoir 62 for cleaning and maintenance purposes. The apparatus 10 may have a heater to maintain the solution at a constant optimal temperature to keep roots of the plants 24 in a healthy state.

In one embodiment, the submersible pump 22 may be attached to the tube 18 by a coupler 40 and may be operated to deliver minimum of 0.5 liter/minute of solution to each plant 24 contained within the apparatus 10 by appropriate programming of the MCU. A relay module (not shown) may alternatively be used for this purpose. The apparatus 10 may have a circuitry to operate the light system 20 and the submersible pump 22 for a pre-determined intervals; in other words the circuitry may enable the apparatus to become semi or fully-programmable. Once fully programmed, the circuitry may make the apparatus fully automated and may operate the light system 20 and the submersible pump 22 based on the ambient light conditions and the time of the day.

Some of the advantages of the present invention over the prior art are that this (a) is smaller in size and scale for an ordinary user to easily use it to harvest plants for personal consumption, (b) can be scaled with relatively low cost, (c) is simple to use for those new to gardening, (d) requires less time and maintenance than other hydroponic systems, (e) uses LEDs to efficiently grow plants at the optimal wavelengths of light, (f) may be used as a counter-top sized vertical planter, (g) does not uses bulky lamps and reflectors that evaporate water and burn plants, (h) can be integrated in any empty space of home or office, as this does not need natural sunlight, therefore does not takes window space, (i) consumes less electricity than prior art, (j) keeps the solution at constant optimal temperature keeping roots healthy, (k) allows disabled and elderly arthritic patients to enjoy gardening without the use of tools or kneeling, (l) can be used to produce healthy organic produce year long, (m) is tall enough to allow user to grow the maximum amount of plants, but short enough to allow user to easily pour solution into the system, and (n) is lightweight and easily movable.

1. A self-contained hydroponic system for growing a plurality of plants configured as plant pods, each pod having a root portion and a foliage portion, the system comprising:
a vessel having a wall with an outer surface, an upper end, and an interior with a reservoir containing an aqueous solution;
the wall of the vessel including a plurality of holes, each adapted to receive one of the plant pods, such that the root portions of the pods are within the interior of the vessel and the foliage portions extend away from the outer surface of the vessel;
a pump connected to an emitter within the interior of the vessel operative to deliver the aqueous solution to the root portions of the plant pods; and
a light system couple to the upper end of the vessel operative to illuminate the foliage portions of the plant pods.

2. The self-contained hydroponic system of claim 1, wherein the pump is a submersible pump connected to the emitter through a fluid conduit.

3. The self-contained hydroponic system of claim 1, wherein the light system includes a plurality of LEDs producing light directed to different areas of the outer surface of the vessel.

4. The self-contained hydroponic system of claim 3, wherein:
the upper end of the vessel has an opening; and
further including a cap configured to cover the opening, the cap having a lower surface including one or more rings of LEDs producing light directed to different areas of the outer surfaces of the vessel.

5. The self-contained hydroponic system of claim 1, further including a plurality of net pots, each configured to hold one of the plant pods in respective openings of the vessel.

6. The self-contained hydroponic system of claim 1, wherein the light system includes a plurality of LEDs of the same or different wavelengths selected to stimulate plant growth.

7. The self-contained hydroponic system of claim 1, further including electrical circuitry to control the pump and light system at the same or different interval to conserve power and/or stimulate plant growth.

8. The self-contained hydroponic system of claim 7, further including a wired or wireless connection to the electrical circuitry to control the light system and/or pump.

9. The self-contained hydroponic system of claim 1, wherein at least a section of the wall of the vessel diverges from top to bottom to keep upper foliage portions from shading lower foliage portions.

10. The self-contained hydroponic system of claim 1, wherein at least a section of the wall of the vessel is conical to keep upper foliage portions from shading lower foliage portions.

11. The self-contained hydroponic system of claim 1, wherein the vessel is vertically oriented to keep upper foliage portions from shading lower foliage portions.

12. The self-contained hydroponic system of claim 1, further including a light sensor that regulates the output of the light system based on the ambient light within the surrounding environment.

13. The self-contained hydroponic system of claim 1, further including a clock module enabling the light system and associated electronic devices return to their proper states following a power outage.

14. The self-contained hydroponic system of claim 1, wherein the light system and/or pump are controlled by application software.

15. The self-contained hydroponic system of claim 1, further including a wall-mounted structure comprising of multiple shelves enabling the plants to be irrigated through a multi-trellis system.

16. The self-contained hydroponic system of claim 1, wherein the aqueous solution is a nutrient-rich solution.

17. The self-contained hydroponic system of claim 1, wherein the pump and light system are controlled by a programmed microcontroller unit (MCU).

18. The self-contained hydroponic system of claim 1, further including a depth sensor to maintain a desired level of the aqueous solution.

19. The self-contained hydroponic system of claim 1, wherein the pump delivers air in addition to the aqueous solution.

20. The self-contained hydroponic system of claim 1, further including a WiFi or other wireless interface enabling monitoring and/or control of the system from a remote location.
